(19) United States
(12) Patent Application Publication
(10) Pub. No.: US 2025/0237051 A1
(43) Pub. Date: Jul. 24, 2025

(54) SIPHON ASSEMBLY

(71) Applicant: VORTECH WATER SOLUTIONS LTD, Galway (IE)

(72) Inventors: Sean Mulligan, Galway (IE); Alan Carty, Galway (IE); Peter Leonard, Galway (IE)

(21) Appl. No.: 18/705,393

(22) PCT Filed: Oct. 31, 2022
(86) PCT No.: PCT/EP2022/080392

§ 371 Date: Apr. 26, 2024

(30) Foreign Application Priority Data
Oct. 29, 2021 (GB) 2115605.4

(51) Int. Cl. E03F 5/20; B01D 35/02; E02B 7/18

(52) U.S. Cl. CPC E03F 5/20; B01D 35/02; E02B 7/18

(57) ABSTRACT

A siphon assembly includes an ascent conduit having a conduit inlet, a descent conduit having a conduit outlet, and a flow passage through the ascent conduit and the descent conduit. The flow passage connects the conduit inlet and the conduit outlet via a siphon crest. The siphon assembly also includes a filter arranged to filter a siphonic flow towards the siphon crest.

### FIELD

The present disclosure relates in general to an overflow management solution and particularly to a siphon assembly.

### BACKGROUND

Various applications in industry require transfer of liquid from a first reservoir to a second reservoir. An example of such an application relates to storm overflows. A particular example of a storm overflow is a combined sewage overflow in a combined sewage system. A combined sewage system provides a wastewater conveyance infrastructure configured to convey wastewater and rainwater. Heavy rainfall may cause the combined sewage system to reach capacity, which would result in an uncontrolled spill or backing up through the system. The combined sewage overflow provides a means for controlled overflow.

Some known examples of combined sewage overflows utilise a weir, i.e. a barrier over which liquid in the first reservoir must flow over in order to reach the second reservoir. In order to inhibit matter carried by the liquid from reaching the second reservoir, it is known to provide moving mesh screens spanning across the weir. These mesh screens require regular maintenance due to moving parts and clogging, involving cleaning means such as spray pipework and, ultimately, replacement under possibly precarious access conditions.

### SUMMARY

According to the present disclosure there is provided a siphon assembly as set forth in the appended claims. Other features of the invention will be apparent from the dependent claims, and the description which follows.

There is provided a siphon assembly comprising an ascent conduit and a descent conduit. The ascent conduit comprises a conduit inlet, the descent conduit comprises a conduit outlet. A flow passage extends through the ascent conduit and the descent conduit, connecting the conduit inlet and the conduit outlet. The siphon assembly further comprises a filter arranged to filter a siphonic flow towards the siphon crest. In use, a depriming event causes backflush through the ascent conduit such that siphonic flow communicated from the filter towards the siphon crest returns to the filter. Thus, the filter may be cleaned by the backwash resulting from depriming, i.e. termination of siphonic flow.

According to some examples, the ascent conduit defines an ascent direction. In use, the ascent direction may correspond to a vertical ‘upwards’ direction.

According to some examples, the conduit inlet forms an inlet opening.

According to some examples, the inlet opening is provided substantially perpendicular to the ascent direction. Orienting the inlet opening of the conduit inlet to be perpendicular to the ascent direction, i.e. in use downward facing, may improve backflushing of the ascent conduit, thereby improving cleaning of the filter.

According to some examples, the inlet opening and/or the filter is provided at an angle in a range of 30 degrees to 60 degrees relative to the ascent direction. Such orientation of the inlet opening may increase capacity by increasing a cross section of the inlet opening and/or the filter, thereby reducing head losses during siphonic. Also, siphonic flow may push solids retained by the filter so orientated along said filter to reduce blockage.

According to some examples, the filter is located closer to the conduit inlet than the siphon crest. According to further examples, the filter is located at the conduit inlet or upstream from the conduit inlet. The location of the filter may be chosen to increase backflush and, hence, further improve filter cleaning. In particular, locating the filter closer to the conduit inlet than to the siphon crest increases the available volume of backflush.

Where the filter is provided at the inlet opening, and both the filter and the inlet opening are at an angle between 30 degrees and 60 degrees, blockage may be particularly reduced since siphonic flow may push solids along and away from the filter.

Where both the inlet opening and the filter are provided at the same angle between 30 degrees to 60 degrees, i.e. the filter is parallel to the inlet opening, head losses may be particularly reduced.

According to some examples, the flow passage comprises a convergent inlet segment. The convergent inlet segment may reduce head losses of siphonic flow into the flow passage. The filter may be located in the convergent inlet segment. Where the filter is located in the convergent inlet segment, the filter is located in a segment of the flow passage with greater cross-section such the filter may be larger. Hence clogging of the filter and head losses at the filter may be reduced. Alternatively, the filter may be located downstream from the convergent inlet segment with reference to the siphonic flow. In other words, the filter may be located between the convergent inlet segment and the siphon crest.

According to some examples, the filter is located in a divergent inlet segment of the flow passage. Alternatively, the divergent inlet segment is located between the filter and the siphon crest, i.e. upstream from the filter. Since the divergent inlet segment is divergent with respect to the siphonic flow, it follows that the divergent inlet segment acts as a convergent with respect to a flow in the reverse direction, i.e. the backflush. As a result, the divergent inlet segment may increase flow velocity at the filter when depriming, such that the cleaning effect on the filter may be improved.

According to some examples, a convergent segment of the flow passage is located between the filter and the siphon crest. In other words, the convergent segment is located downstream from the filter with reference to the siphonic flow, and is located upstream from the siphon crest with reference to the siphonic flow. Providing the convergent segment of the flow passage between the filter and the siphon crest means that the flow passage has a greater cross-section towards the filter. Accordingly, the volume of the flow passage available for a backflush towards the filter is increased. Hence the convergent segment may improve cleaning of the filter.

According to some examples, the siphon assembly comprises a secondary ascent conduit. The secondary ascent conduit comprises a depriming inlet and extends to a secondary conduit inlet to the flow passage. The secondary conduit inlet is located between the filter and the siphon crest, i.e. is located downstream from the filter and upstream from the siphon crest with reference to the siphonic flow. A secondary flow passage through the secondary ascent conduit connects the depriming inlet and the secondary conduit inlet. In use, the secondary flow passage may improve depriming and may be utilised for purposes of filter cleaning, for example using pressurised fluid injected into secondary conduit inlet by suitable means.

According to some examples, the depriming inlet forms a depriming opening at an angle relative to the ascent direction. The angle may be in a range between 30 degrees and 60 degrees.

According to some examples, the secondary ascent conduit defines a depriming slot. The depriming slot extends from the depriming opening along the secondary ascent conduit. Thus the depriming slot effectively extends the depriming opening. In use, the depriming slot may enable a gradual cut-off when depriming the siphon. During backflush, the depriming slot may supress flow instabilities and oscillations, for example resulting from smaller changes of reservoir level.

According to some examples, the secondary flow passage comprises a convergent depriming inlet segment. The convergent depriming inlet segment of the secondary flow passage may improve depriming by enabling a gradual cut-off.

According to some examples, the secondary flow passage comprises a divergent segment. The divergent segment may be located at the secondary conduit inlet. The divergent segment of the secondary flow passage may assist in air entrainment during priming of the siphon and may also assist air de-entrainment during depriming.

According to some examples, the secondary conduit inlet is configured to receive pressurised fluid into the flow passage. Pressurised fluid may be utilised for cleaning of the filter. Particularly in a situation where the backflush upon depriming is insufficient for sufficient filter cleaning, pressurised fluid may be used to increase the backflush or may be utilised separately from the backflush for filter cleaning. Also, pressurised fluid may be utilised for depriming.

According to some examples, the descent conduit comprises a secondary conduit outlet. The secondary conduit outlet may be located between the siphon crest and the conduit outlet.

According to some examples, the filter comprises a central portion and a first pair of side portions. The central portion may be provided between the side portions and located downstream of the side portions.

According to some examples, the filter comprises a second pair of side portions. A first side portion of the second pair may be located downstream of a second side portion of the second pair.

According to some examples, the filter is removable from the ascent conduit. For example, the filter may be manually removable from the ascent conduit.

According to some examples, there is provided an overflow management solution comprising the siphon assembly as described above. The overflow management solution may further comprise a first liquid reservoir and a second reservoir, and a wall separating the first liquid reservoir and the second liquid reservoir. The siphon assembly is configured to siphon liquid from the first reservoir to the second reservoir.

According to some examples, the overflow management solution comprises a plurality of siphon assemblies. Each siphon assembly of the plurality of siphon assemblies may be configured to siphon liquid the first reservoir to the second reservoir.

According to some examples, a first siphon assembly of the plurality of siphon assemblies has a conduit inlet at a first elevation, and a second siphon assembly of the plurality of siphon assemblies has a conduit inlet at a second elevation.

### BRIEF DESCRIPTION OF DRAWINGS

For a better understanding of the invention, and to show how example embodiments may be carried into effect, reference will now be made to the accompanying drawings in which:

FIG. 1 is a sectional view of an exemplary siphon assembly mounted on a wall between two reservoirs;

FIG. 2 is a sectional view of the siphon assembly of FIG. 1;

FIG. 3 is a perspective view of the siphon assembly of FIG. 1;

FIG. 4 is a sectional view of an ascent conduit of the siphon assembly of FIG. 1;

FIG. 5 is a sectional view of a descent conduit of the siphon assembly of FIG. 1;

FIG. 6 is a sectional view of a secondary ascent conduit of the siphon assembly of FIG. 1;

FIG. 7 is a sectional view of the exemplary siphon assembly of FIG. 1 wherein a liquid is accumulating in a first reservoir of the two reservoirs;

FIG. 8 is a sectional view of the exemplary siphon assembly of FIG. 1 wherein the liquid in a first reservoir of the two reservoirs is being siphoned into a second reservoir of the two reservoirs;

FIG. 9 is a sectional view of the exemplary siphon assembly of FIG. 1 wherein siphoning action is being deprimed;

FIG. 10 is a sectional view of the exemplary siphon assembly of FIG. 1 in a fully deprimed configuration;

FIG. 11 is a front view of a plurality of siphon assemblies arranged in parallel;

FIG. 12 is a sectional view of another exemplary siphon assembly;

FIG. 13 is a sectional view of another exemplary siphon assembly;

FIG. 14 is a sectional view of another exemplary siphon assembly;

FIG. 15 is a sectional view of another exemplary siphon assembly;

FIG. 16 is a front view of another exemplary siphon assembly;

FIG. 17 is a front view of another exemplary siphon assembly;

FIG. 18 is a sectional view of another exemplary siphon assembly;

FIG. 19 is a front view of the siphon assembly of FIG. 18.

### DESCRIPTION OF EMBODIMENTS

The present application relates to an overflow management solution and, more particularly, to a passive overflow management solution. The overflow solution is configured to screen floatable and neutrally buoyant debris, rags, fibrous material, eliminate air entrainment without requiring moving parts.

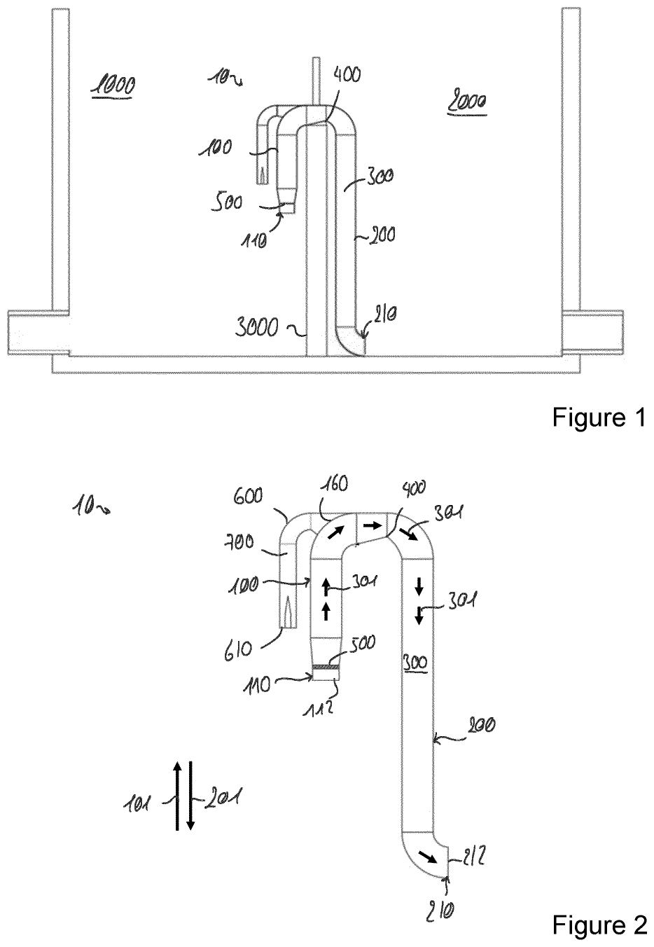

FIG. 1 is a sectional view of an exemplary siphon assembly 10. The siphon assembly 10 is an apparatus for conveying liquid. More particularly, the siphon assembly 10 is arranged to siphon liquid from a first reservoir 1000 (or ‘first cell’) into a second reservoir 2000 (or ‘second cell’). The reservoirs 1000, 2000 define volumes for holding liquid. According to the present example, the reservoirs 1000, 2000 are separated by a wall 3000 (or ‘weir’). The siphon assembly 10 is mounted on the wall 3000 and is arranged to convey liquid over the wall 3000.

The siphon assembly 10 comprises an ascent conduit 100 and a descent conduit 200. In combination, the ascent conduit 100 and the descent conduit 200 convey liquid by means of siphonic action along a flow passage 300. Liquid is drawn into a conduit inlet 110 of the ascent conduit 100 and communicated along the flow passage 300 to a conduit outlet 210 of the descent conduit 200 from where the liquid is discharged. Thus, siphonic action defines a siphonic flow sequence wherein the conduit outlet 210 is located downstream of the conduit inlet 110 and, conversely, the conduit inlet 110 is located upstream of the conduit outlet 210.

Along the flow passage 300 is a siphon crest 400. The siphon crest 400 provides a boundary to the flow passage 300 which, in use, is a lower boundary at maximum elevation. In use, liquid ascends through the ascent conduit 100 until reaching the siphon crest 400 and subsequently descends from the siphon crest 400 through the descent conduit 200. With reference to the siphonic flow sequence, the conduit inlet 110 is located upstream of the siphon crest 400 and the siphon crest 400 is located upstream of the conduit outlet 210.

The siphon assembly 10 comprises a filter 500 arranged to filter liquid conveyed by the siphon assembly 10. The filter 500 is located upstream of the siphon crest 400 with reference to the siphonic flow sequence. In use, siphonic action causes liquid to pass through the filter 500 and subsequently flow past the siphon crest 400, i.e. maximum elevation. In other words, the filter 500 is arranged to filter a siphonic flow towards the siphon crest 400. Upon termination of the siphonic action, the flow sequence reverses in the ascent conduit 100 such that flow towards the siphon crest 400 returns to and passes through the filter 500 as a backflush. With respect to the inverted flow sequence, the filter 500 is downstream from the siphon crest 400.

The filter 500 is located in the ascent conduit 100. More particularly, the filter 500 is provided in a segment of the flow passage 300 defined by the ascent conduit 100. Liquid ascending through the ascent conduit 100 passes through the filter 500 and subsequently reaches the siphon crest 400. When siphoning ends, liquid located in the ascent conduit 100 will descend in the ascent conduit 100 as the backflush. In particular, any liquid present between the filter 500 and the siphon crest 400 will pass through the filter 500.

Thus, there is provided a passive overflow management solution which is configured to filter a flow communicated between reservoirs 1000, 2000 and further configured to self-clean.

FIG. 2 is a sectional view of the siphon assembly 10. The sectional view of FIG. 2 of the siphon assembly 10 corresponds to FIG. 1, but the first reservoir 1000, the second reservoir 2000 and the wall 3000 are not shown in FIG. 2.

The ascent conduit 100 (or “first conduit”) is a structure configured to communicate fluid. More particularly, the ascent conduit 100 defines an ascent direction 101 (or “first direction”) and is configured to communicate liquid in the ascent direction 101 under siphonic action. In use, the ascent direction 101 corresponds to an upwards direction. That is to say, in use the ascent conduit 100 communicates liquid upwards.

The descent conduit 200 (or “second conduit”) is another structure configured to communicate fluid. The descent conduit 200 defines a descent direction 201 (or “second direction”) and is configured to communicate liquid in the descent direction 201 under siphonic action. In use, the descent direction 201 corresponds to a downwards direction. In other words, the descent conduit 200 communicates liquid downwards. Thus, the ascent direction 101 and the descent direction 201 are opposite directions.

The flow passage 300 of the siphon assembly 10 defines a siphoning direction 301 (or “siphonic flow direction”). Since flow through the siphon assembly 10 follows the flow passage 300, the siphoning direction 301 is location dependent and so differs along the flow passage 300. In FIG. 2, the siphoning direction 301 is indicated along the flow passage 300 using a plurality of arrows. For siphonic flow, the siphoning direction 301 coincides with the ascent direction 101 in the ascent conduit 100, and coincides with the descent direction 201 in the descent conduit 200.

Liquid is drawn into the ascent conduit 100 through an inlet opening 112 (or “first opening”) defined by the conduit inlet 110 (or “conduit inlet port” or “first port”). The inlet opening 112 provides an opening in flow communication with the flow passage 300. In other words, the inlet opening 112 is configured to receive liquid into the flow passage 300. The inlet opening 112 is perpendicular to the ascent direction 101 and/or the siphoning direction 301.

Liquid is discharged from the descent conduit 200 through an outlet opening 212 (or “second opening”) defined by the conduit outlet 210 (or “conduit outlet port” or “second port”). The outlet opening 212 provides an opening in flow communication with the flow passage 300 for discharging liquid from the flow passage 300.

In addition to the ascent conduit 100 and the descent conduit 200, the siphon assembly 10 comprises a secondary ascent conduit 600. The secondary ascent conduit 600 (or “third conduit”) is yet another structure configured to communicate fluid. The secondary ascent conduit 600 is provided as a means for depriming, i.e. termination of the siphonic action. In particular, the secondary ascent conduit 600 provides an alternative passage to the ascent conduit 100 for a depriming flow, e.g. ambient air, to reach the flow passage 300.

The secondary ascent conduit 600 extends along the ascent conduit 100 and is provided parallel to the ascent direction 101. More particularly, the secondary ascent conduit 600 extends along part of the ascent conduit 100 but not along the whole ascent conduit 100.

The secondary ascent conduit 600 defines a secondary flow passage 700 between a depriming inlet 610 (or “depriming inlet port” or “third port”) to the secondary ascent conduit 600 and a secondary conduit inlet 160 to the ascent conduit 100.

The depriming inlet 610 is elevated related to the conduit inlet 110 of the ascent conduit 100. Here “elevated” is used with reference to the ascent direction 101 defined by the ascent conduit 100, which the skilled person understands to define a natural ‘upwards’ direction. Thus, in use the depriming inlet 610 is exposed even where the conduit inlet 110 remains submerged. In a situation where the siphon assembly 10 is primed and the depriming inlet 610 exposed, the exposed depriming inlet 610 communicates a depriming flow into the secondary flow passage 700. Said depriming flow passes through the secondary conduit inlet 160 and thus into the flow passage 300 to cause depriming. Suitably, the secondary conduit inlet 160 is provided upstream of the siphon crest 400.

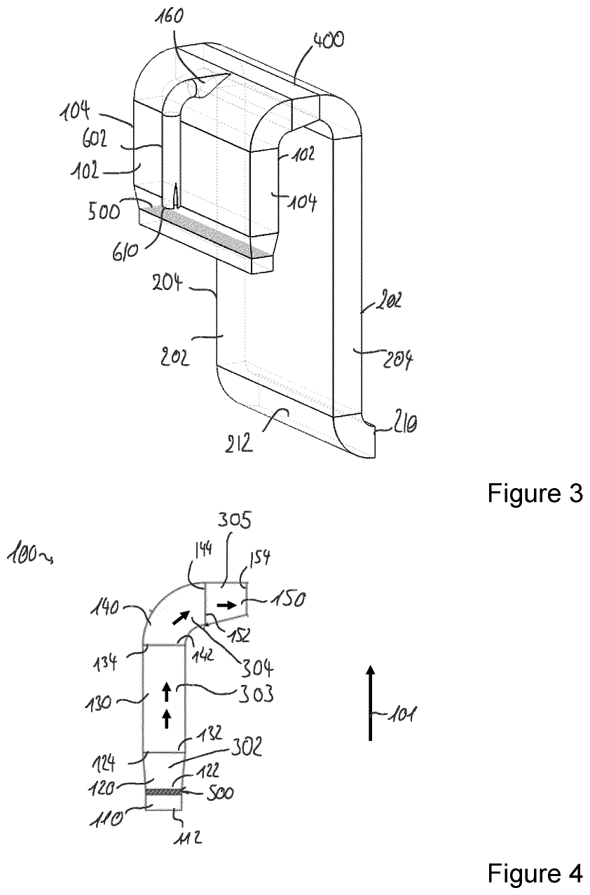

FIG. 3 shows a perspective view of the siphon assembly 10.

The flow passage 300 has a substantially rectangular cross-section. That is to say, the flow passage 300 has a substantially rectangular cross-sectional profile in a direction perpendicular to the siphoning direction 301.

The ascent conduit 100 comprises a first pair of walls 102 and a second pair of walls 104. The first pair of walls 102 bounds the flow passage 300 in a first direction, while the second pair of walls 104 bound the flow passage 300 in a second direction perpendicular to the first direction. The first pair of walls 102 delimit a width of the ascent conduit 100, while the second pair of walls 104 delimits a depth of the ascent conduit 100. The depth of the ascent conduit 100 is smaller than the width of the ascent conduit 100. Correspondingly, the flow passage 300 is wider than the flow passage 300 is deep.

Similarly, the descent conduit 200 comprises a first pair of walls 202 and a second pair of walls 204 bounding the flow passage 300. Similar as for the ascent conduit 100, the walls 202, 204 of the descent conduit 200 delimit a width that is greater than a depth of the descent conduit 200.

The secondary ascent conduit 600 comprises a tubular wall 602. The tubular wall 602 bounds the secondary flow passage 700 in a cross-sectionally radial direction.

FIG. 4 is a sectional view of the ascent conduit 100. Flow through the siphon assembly 10 passes through the conduit inlet 110 and subsequently passes through a plurality of ascent sections 120, 130, 140, 150 of the ascent conduit 100. The plurality of ascent sections includes, in siphonic flow sequence, a first ascent section 120, a second ascent section 130, a third ascent section 140, and a fourth ascent section 150. The conduit inlet 110 is located upstream of the ascent sections.

The first ascent section 120 of the ascent conduit 100 defines an inlet segment 302 of the flow passage 300. According to the present example, the first ascent section 120 is provided as an inverted funnel 120 such that the inlet segment 302 is divergent, i.e. a cross-sectional size of the flow passage 300 increases in the direction of siphonic flow 301. Accordingly, an inlet 122 of the first ascent section 120 has a smaller cross-sectional size than an outlet 124 of the first ascent section 120.

The second ascent section 130 defines a straight segment 303 of the flow passage 300. The straight segment 303 has a constant cross-sectional profile and projects along the ascent direction 101. An inlet 132 of the second ascent section 130 has the same cross-sectional size as an outlet 134 of the second ascent section 130, and moreover the cross-sectional size is substantially unchanged between the inlet 132 and the outlet 134 to the second ascent section 130.

The third ascent section 140 defines a curved segment 304 of the flow passage 300. The curved segment 304 has a constant cross-sectional profile and is curved. More particularly, the curved segment 304 defines a 90-degree turn of the flow passage 300. An inlet 142 of the third ascent section 140 has the same cross-sectional size as an outlet 144 of the third ascent section 140, and the cross-sectional size remains substantially unchanged between the inlet 142 and the outlet 144 to the third ascent section 140 along the curve defined thereby.

The fourth ascent section 150 defines a convergent segment 305 of the flow passage 300. An inlet 152 of the fourth ascent section 150 has a larger cross-sectional size than an outlet 154 of the first ascent section 120. According to the present example, the fourth ascent section 150 terminates at the siphon crest 400.

The siphon crest 400 is located downstream from the ascent conduit 110 and upstream from the descent conduit 210. According to the present example, the siphon crest 400 corresponds to a constriction of the flow passage 300. The constriction is a minimum cross-sectional size of the flow passage 300, which increases upstream and downstream from the siphon crest 400.

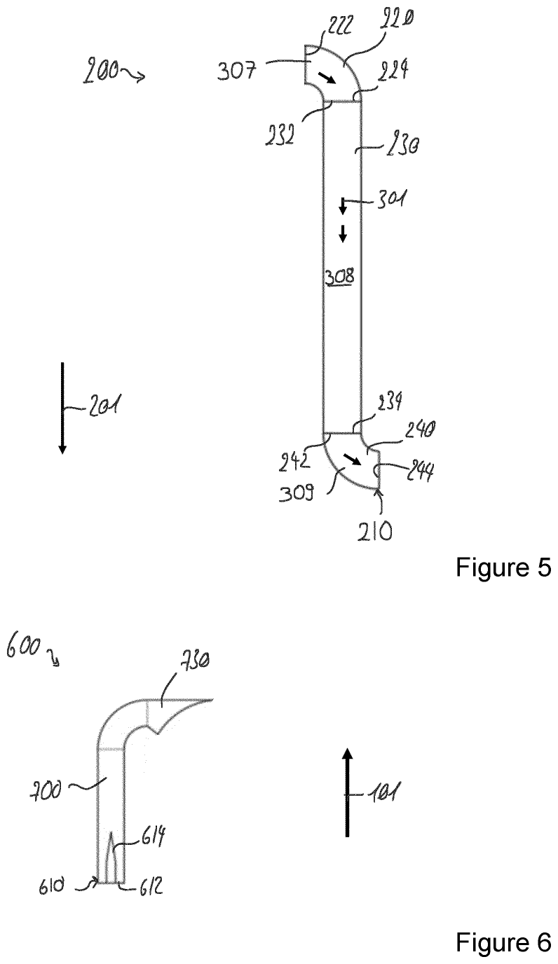

FIG. 5 is a sectional view of the descent conduit 200. Following passage of the siphon crest 400, the siphonic flow passes through a plurality of descent sections 220, 230, 240; and subsequently through the conduit outlet 210. The plurality of descent sections comprises a first descent section 220, a second descent section 230 and a third descent section 240.

The first descent section 220 defines another curved segment 307 of the flow passage 300. The curved segment 307 has a constant cross-sectional profile and is curved. More particularly, the curved segment 307 defines a 90-degree turn of the flow passage 300. An inlet 222 of the first descent section 220 has the same cross-sectional size as an outlet 224 of the first descent section 220, and the cross-sectional size remains substantially unchanged between the inlet 222 and the outlet 224 to the first descent section 220 along the curve defined thereby. In combination, the curved segments 304, 307 divert flow by 180 degrees, thus diverting a flow in the ascent direction 101 into a flow in the descent direction 201.

The second descent section 230 defines another straight segment 308 of the flow passage 300. The straight segment 308 has a constant cross-sectional profile and projects along the descent direction 201. An inlet 232 of the second descent section 230 has the same cross-sectional size as an outlet 234 of the second descent section 230, and moreover the cross-sectional size is substantially unchanged between the inlet 232 and the outlet 234 to the second descent section 230. According to the present example, the second ascent section 130 of the ascent conduit 100 is shorter than the second descent section 230 of the descent conduit 200.

The third descent section 240 defines yet another curved segment 309 of the flow passage 300. The curved segment 309 has a constant cross-sectional profile and is curved. More particularly, the curved segment 309 defines a 90-degree turn of the flow passage 300. An inlet 242 of the third descent section 240 has the same cross-sectional size as an outlet 244 of the third descent section 240, and the cross-sectional size remains substantially unchanged between the inlet 242 and the outlet 244 to the third descent section 240 along the curve defined thereby. In use, the third descent section 240 levels out a vertically downwards flow by turning through 90 degrees.

FIG. 6 is a sectional view of the secondary ascent conduit 600.

The secondary ascent conduit 600 defines a divergent segment 730 of the secondary flow passage 700. A cross-sectional size of the secondary flow passage 700 increases in the divergent secondary segment 730 of the secondary flow passage 700. According to the present example, the divergent secondary segment 730 terminates at the secondary conduit inlet 160.

The secondary ascent conduit 600 is provided with a slot 614 through the secondary ascent conduit 600, i.e. through the tubular wall 602. The slot 614 provides an extension of the depriming opening 612 defined by the depriming inlet 610. Extending from the depriming inlet 610 in the ascent direction 101, in use the slot 614 draws in a depriming flow even where the depriming inlet 610 is submerged.

The secondary conduit inlet 160 is in flow communication with a fluid pump (not shown) configurable to purge the flow passage 300. According to the present example, the fluid pump is in flow communication with the secondary ascent conduit 600 by means of a suitable inlet (not shown) into the secondary flow passage 700.

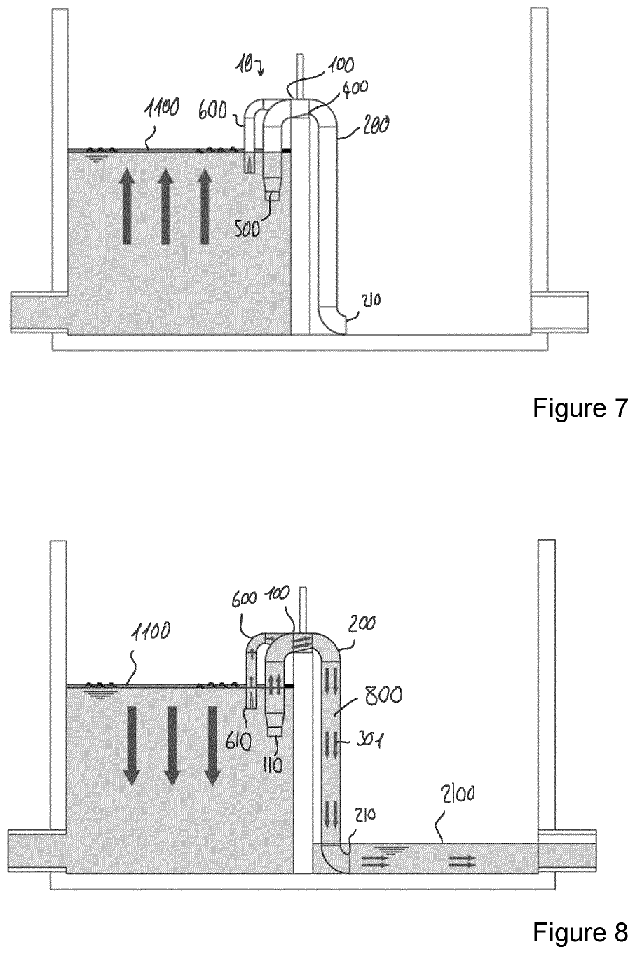

FIGS. 7 to 10 illustrate operation of the siphon assembly 10. More particularly, the siphon assembly 10 is that shown in FIG. 1 but illustrating different flow regimes.

FIG. 7 shows a flow regime wherein water, or more generally any other suitable liquid, accumulates in the first reservoir 1000 and a water level 1100 in the first reservoir 1000 rises. In use this would occur due to inflow into the first reservoir 1000 exceeding outflow from the first reservoir 1000. The siphon assembly 10 is not primed; pressure in the siphon assembly 10 during this regime is atmospheric.

As the water level rises, eventually the conduit inlet 110, the filter 500 and the secondary conduit inlet 610 are submerged. At this stage, mainly neutrally buoyant substances may reach the filter 500 which is configured to inhibit passage. Floatable substances, such as FOGs (fats, oils and greases) may also collect particularly as the water level 1100 rises past the conduit inlet 110 but subsequently will be located above the conduit inlet 110. Material collected by the filter 500 will be larger than the size of the maximum apertures in the filter 500.

FIG. 8 shows a siphonic flow 800 though the siphon assembly 10. As the water level 1100 of FIG. 7 rises further in the first reservoir 1000, water eventually overflows the siphon crest 400 into the descent conduit 200 and into the second reservoir 2000. Ultimately the water will trigger an air flushing of the conduits 100, 200. At this point, no ambient air enters the system, resulting in sub-atmospheric pressures as the siphon assembly 10 is primed. The driving pressure for flow conveyance is the differential between the water level 1100 in the first reservoir 1000 and a water level 2100 in the second reservoir 2000.

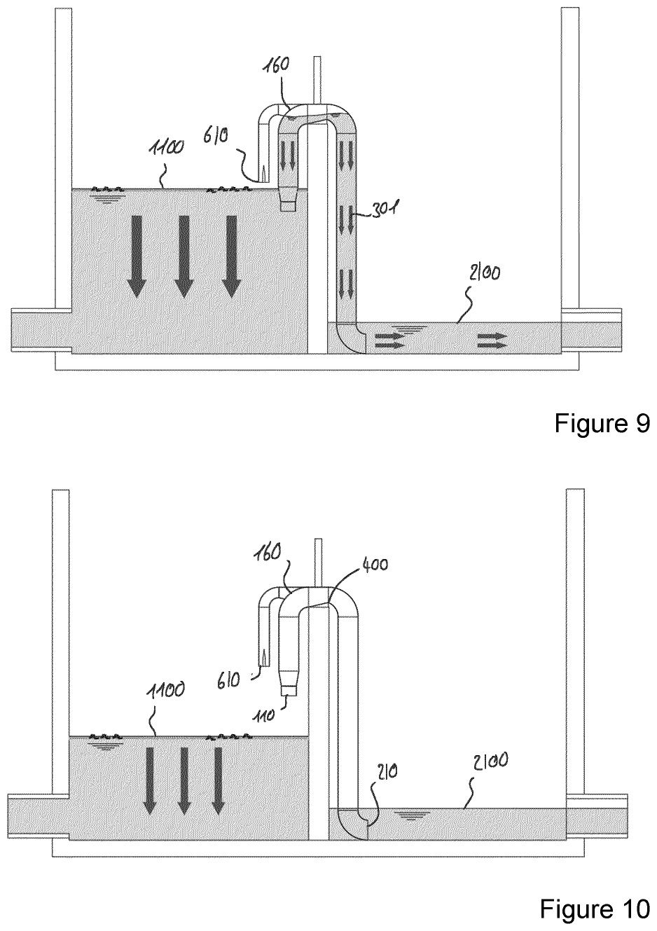

FIG. 9 shows the siphon assembly 10 undergoing depriming, i.e. cessation of siphoning. When the water level 1100 in the first reservoir 1000 decreases to reveal the depriming inlet 610, air will entrain to cause a cessation of the vacuum and the internal pressure will return to atmospheric pressure. At this point, the water level inside the ascent conduit 100 is higher than the water level 1100 in the first reservoir 1000, such that the volume of water retained in the ascent conduit 100 will be released in a backflush into the first reservoir 1000. During the backflush, solids retained by the filter 500, and especially on an upstream side of the filter 500, may be washed off.

FIG. 10 shows siphon assembly 10 after siphoning has ceased. The water level in the first reservoir 1000 receded below the conduit inlet 110 and no further siphoning through the flow passage 300 takes place.

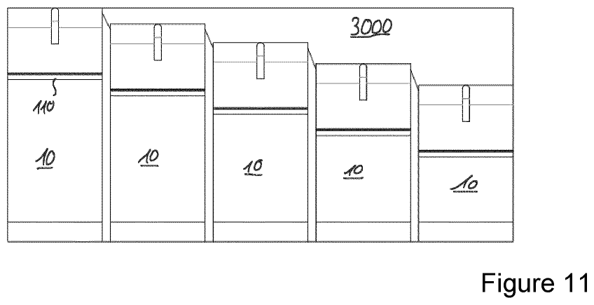

FIG. 11 is a front view of a plurality of siphon assemblies 10. The plurality of siphon assemblies 10 is arranged in parallel to increase the discharge from the first reservoir 1000 to the second reservoir 2000 as described previously for a single siphon assembly 10. The siphon assemblies 10 are arrayed side-by-side and the plurality of siphon assemblies 10 is modularly expandable to increase siphoning capacity.

According to the example of FIG. 11, siphon assemblies 10 are arranged in parallel such that the conduit inlets 110 of the siphon assemblies 10 are at different elevations. Thus, a first siphon assembly 10 with a conduit inlet 110 at a lower elevation would begin siphoning at a lower water level, while a second siphon assembly 10 with a conduit inlet 110 at a higher elevation would begin siphoning at a higher water level. The siphon assemblies 10 are therefore arranged to increase the discharge from the first reservoir 1000 to the second reservoir 200 as the water level 1100 in the first reservoir 1000 increases.

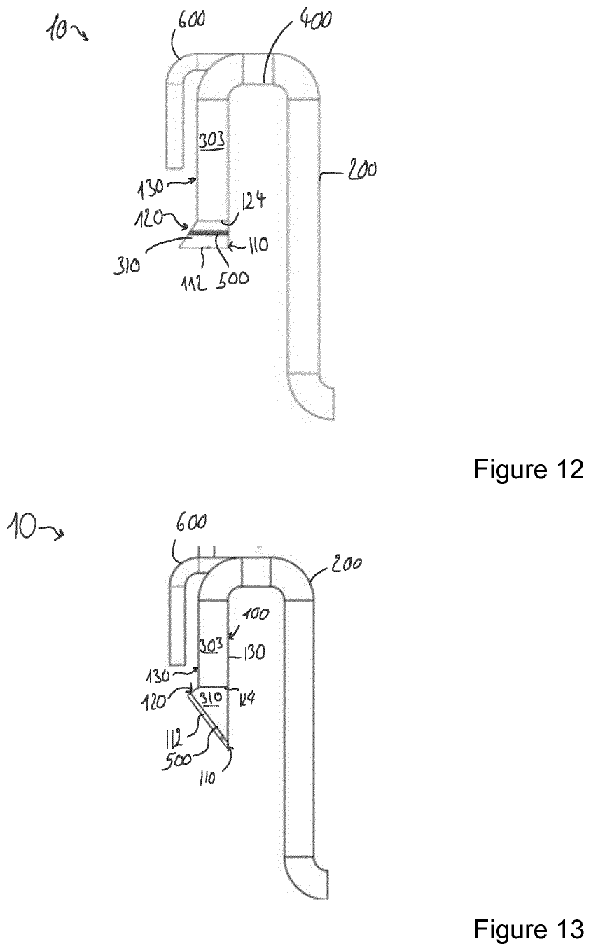

FIG. 12 is a sectional view of the siphon assembly 10 wherein the first ascent section 120 is provided in the form of an inlet funnel 120. The inlet funnel 120 is provided downstream from the conduit inlet 110 and establishes flow communication between the conduit inlet 110 and other upstream segments of the ascent conduit 100. The inlet funnel 120 provides a convergent inlet segment 310 of the flow passage 300, i.e. defines a convergent inlet segment 310. That is to say, the flow passage 300 converges in the direction of siphonic flow 301 in the inlet funnel 120. In other words, the inlet opening 112 of the conduit inlet 110 has a greater cross-sectional area than the outlet 124 of the inlet funnel 120.

According to the present example, the filter 500 is mounted in the inlet funnel 120. More particularly, the filter 500 is located between the conduit inlet 110 and the outlet 124 of the inlet funnel 120.

FIG. 13 shows another sectional view of the siphon assembly 10 provided with a further example of the inlet funnel 120. The filter 500 is provided in the inlet opening 112 of the conduit inlet 110, and both the inlet opening 112 and the filter 500 are provided at an angle relative to the ascent direction 101. This angle is between 30 degrees and 60 degrees, and may be approximately 45 degrees.

In use, the inlet funnel 120 controls the direction of flow onto the filter 500 and may reduce intake head losses in the depriming cycle. Also, the inlet funnel 120 is configured to increase the flow velocity of the backflush through the filter 500.

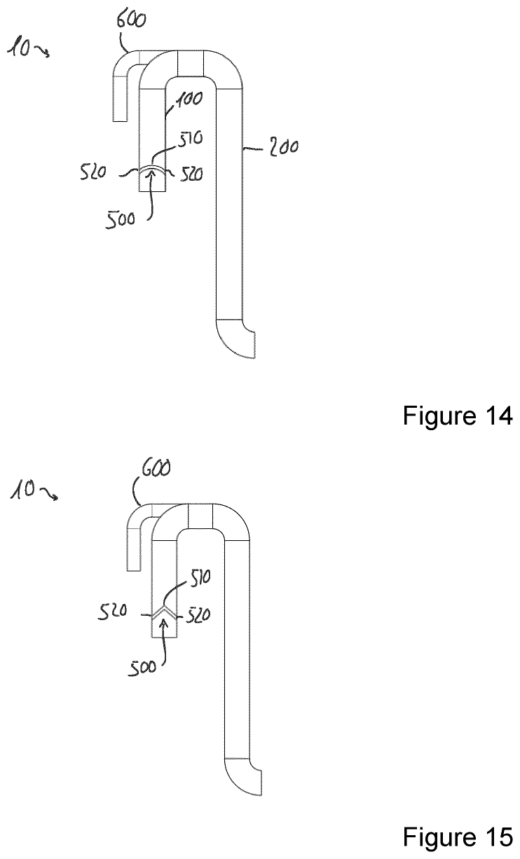

FIGS. 14 to 17 are views of the siphon assembly 10 illustrating exemplary configurations of the filter 500. In each of the examples of FIGS. 14 to 16, the filter 500 comprises a central portion 510 and a pair of side portions 520 bounding a lateral extent of the filter 500. The central portion 510 is provided between the side portions 520, i.e. the side portions 520 are arranged to flank the central portion 510.

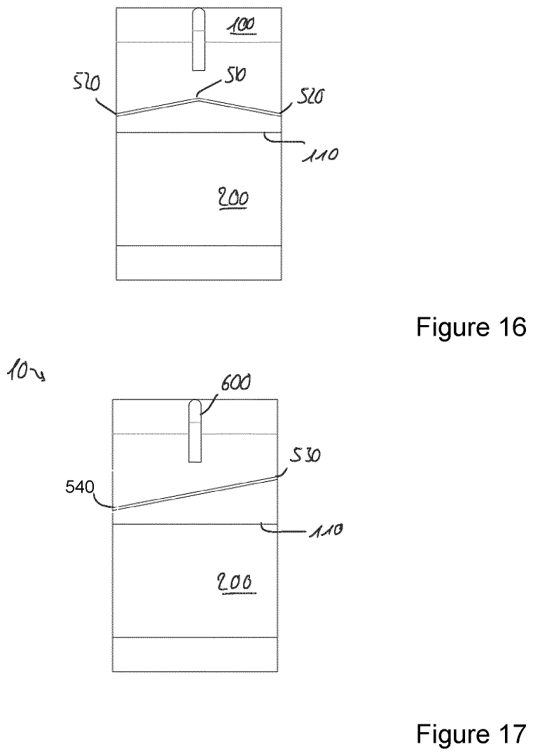

According to the example of FIG. 14, the filter 500 is curved in cross-section. According to the examples of FIGS. 15 and 16, the filter 500 is chevron-shaped in cross-section. More particularly, the filter 500 is chevron-shaped in cross-section through a longitudinal extent of the filter 500 in FIG. 15; and the filter 500 is chevron-shaped in cross-section through a lateral extent of the filter 500 in FIG. 16.

The filter 500 is provided in the ascent conduit 100 in each of the examples of FIGS. 14 to 16 such that the central portion 510 of the filter 500 is located downstream of the side portions 520. The central portion 510 is in use at a higher elevation than the side portions 520, with the central portion 510 defining an apex of the filter 500. Thus, a sloped configuration of the filter 500 is provided.

FIG. 17 shows another exemplary configuration of the filter 500. The filter 500 comprises another pair of side portions 530, 540 bounding a longitudinal extent of the filter 500. A first side portion 530 is in use located at a higher elevation than the second side portion 540. In other words, the first side portion 530 is located downstream of the second side portion 540 with reference to the direction of siphonic flow 301.

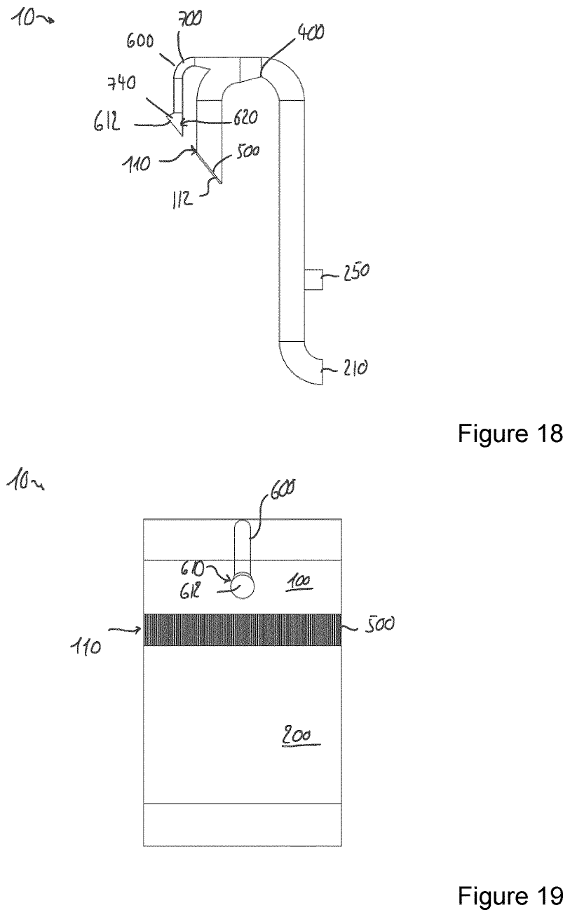

FIGS. 18 and 19 show another exemplary siphon assembly 10. FIG. 18 is a sectional view, while FIG. 19 is a front view of the siphon assembly 10. The siphon assembly 10 of FIGS. 18 and 19 generally corresponds to the siphon assemblies as described with reference to the earlier examples.

The conduit inlet 110 of the siphon assembly 10 is slanted. More particularly, the inlet opening 112 of the conduit inlet 110 is provided at an angle relative to the ascent direction 101. According to the present example, this angle is 45 degrees.

The filter 500 is located in the inlet opening 112 and provided at the same angle as the inlet opening 112. Thus, the filter 500 coincides with the inlet opening 112 and is generally flush with the conduit inlet 110.

Similar to the ascent conduit 100, the depriming opening 612 of the depriming inlet 610 of the secondary ascent conduit 600 is also slanted. According to the present example, the depriming inlet 610 is slanted at the same angle of 45 degrees relative to the ascent direction 101.

The secondary flow passage 700 comprises a convergent depriming inlet segment 740 (or ‘convergent secondary inlet segment’). The convergent depriming inlet segment 740 converges from the conduit inlet 610 in the direction of siphonic flow 301. In other words, the cross-section of the secondary flow passage 700 decreases from the conduit inlet 610 towards the secondary conduit inlet 160 of the ascent conduit 100.

According to the present example, the slanted depriming inlet 610 and the convergent depriming inlet segment 740 are provided by a secondary inlet funnel 620.

The descent conduit 200 comprises a secondary conduit outlet 250. The secondary conduit outlet 250 is located between the siphon crest 400 and the conduit outlet 210. That is to say, the secondary conduit outlet 250 is provided upstream of the conduit outlet 210 with reference to the direction of siphonic flow 301.

Further variants are described below.

The siphon crest 400 as described above, for example with reference to FIG. 2, is sharp but according to other examples the siphon crest 400 may be provided as a flat crest.

The flow passage 300 as described above is substantially rectangular. That is to say, a cross-section of the flow passage 300 in the direction of siphonic flow 301 has a substantially rectangular profile. According to other examples, other cross-sectional shapes may be provided, such as circular.

According to some examples, the filter 500 is removable and, in particular, manually removable. Suitably the filter 500 may be moveable on guide rails or other suitable means to enable manual insertion into the flow passage 300 and removal from the flow passage 300.

The filter 500 may be provided as a mesh screen, for example from gauze or wire mesh. The filter 500 may alternatively be louvered.

The filter 500 may be provided with any suitable configuration of apertures, for example circular or square apertures. Where a louvered filter 500 is provided, the apertures would be longitudinal slots.

In summary, exemplary embodiments of a siphon assembly have been described. The described exemplary embodiments provide for an improved siphon assembly. Additionally, the described exemplary embodiments are convenient to manufacture and straightforward to use.

The siphon assembly may be manufactured industrially. An industrial application of the example embodiments will be clear from the discussion herein.

Although preferred embodiment(s) of the present invention have been shown and described, it will be appreciated by those skilled in the art that changes may be made without departing from the scope of the invention as defined in the claims.

1-19. (canceled)

20. A siphon assembly, comprising:
an ascent conduit including a conduit inlet;
a descent conduit including a conduit outlet;
a siphon crest;
a flow passage through the ascent conduit and the descent conduit, wherein the flow passage connects the conduit inlet and the conduit outlet via the siphon crest;
a filter arranged to filter a siphonic flow that flows in a siphonic flow direction towards the siphon crest;
a secondary conduit inlet to the flow passage located downstream from the filter and upstream from the siphon crest with reference to the siphonic flow direction;
a secondary ascent conduit including a depriming inlet; and
a secondary flow passage through the secondary ascent conduit, wherein the secondary flow passage connects the depriming inlet to the secondary conduit inlet.

21. The siphon assembly according to claim 20, wherein:
the ascent conduit defines an ascent direction;
the conduit inlet forms an inlet opening at an angle relative to the ascent direction, the angle being in a range between 30 degrees and 60 degrees; and
the filter is located at the inlet opening and is provided parallel to the inlet opening.

22. The siphon assembly according to claim 20, wherein:
the ascent conduit defines an ascent direction; and
the conduit inlet forms an inlet opening substantially perpendicular to the ascent direction.

23. The siphon assembly according to claim 22, wherein the filter is located closer to the conduit inlet than the siphon crest.

24. The siphon assembly according to claim 20, wherein the filter is located in a convergent inlet segment of the flow passage or wherein the filter is located between the convergent inlet segment and the siphon crest.

25. The siphon assembly according to claim 20, wherein the filter is located in a divergent inlet segment of the flow passage or wherein the divergent inlet segment is located between the filter and the siphon crest.

26. The siphon assembly according to claim 20, wherein a convergent segment of the flow passage is located between the filter and the siphon crest.

27. The siphon assembly according to claim 20, wherein the depriming inlet forms a depriming opening at an angle relative to the ascent direction, and wherein the angle is in a range of 30 degrees to 60 degrees.

28. The siphon assembly according to claim 27, wherein the secondary ascent conduit defines a depriming slot extending from the depriming opening along the secondary ascent conduit.

29. The siphon assembly according to claim 20, wherein the secondary flow passage comprises a convergent depriming inlet segment.

30. The siphon assembly according to claim 20, wherein the secondary flow passage comprises a divergent segment at the secondary conduit inlet.

31. The siphon assembly according to claim 20, wherein the secondary conduit inlet is configured to receive pressurized fluid into the flow passage.

32. The siphon assembly according to claim 20, wherein the descent conduit comprises a secondary conduit outlet, and wherein the secondary conduit outlet is located between the siphon crest and the conduit outlet.

33. The siphon assembly according to claim 20, wherein the filter comprises a central portion and a first pair of side portions, and wherein the central portion is provided between the side portions and located downstream of the side portions.

34. The siphon assembly according to claim 20, wherein the filter comprises a pair of side portions, and wherein a first side portion of the pair of side portions is located downstream of a second side portion of the pair of side portions.

35. The siphon assembly according to claim 20, wherein the filter is manually removable from the ascent conduit.

36. An overflow management solution, comprising:
a siphon assembly according to claim 20;
a first liquid reservoir and a second liquid reservoir; and
a wall separating the first liquid reservoir and the second liquid reservoir,
wherein the siphon assembly is configured to siphon liquid from the first reservoir to the second reservoir.

37. The overflow management solution according to claim 36, further comprising:
a plurality of the siphon assemblies,
wherein each siphon assembly of the plurality of siphon assemblies is configured to siphon liquid from the first reservoir to the second reservoir.

38. The overflow management solution according to claim 37, wherein:
a first siphon assembly of the plurality of siphon assemblies has a conduit inlet at a first elevation;
a second siphon assembly of the plurality of siphon assemblies has a conduit inlet at a second elevation; and
the first elevation and the second elevation are different.
